(19) United States
(12) Patent Application Publication
(10) Pub. No.: US 2025/0219212 A1
(43) Pub. Date: Jul. 3, 2025

(54) METHOD FOR MANUFACTURING A POWER STORAGE DEVICE

(71) Applicant: Prime Planet Energy & Solutions, Inc., Tokyo (JP)

(72) Inventor: Katsuya SHIKATA, Nisshin-shi (JP)

(21) Appl. No.: 18/959,633

(22) Filed: Nov. 26, 2024

(30) Foreign Application Priority Data
Dec. 28, 2023 (JP) 2023-223223

(51) Int. Cl. H01M 50/169; H01M 10/0587; H01M 10/48

(52) U.S. Cl. CPC H01M 50/169; H01M 10/0587; H01M 10/486

(57) ABSTRACT

In a method for manufacturing a power storage device, when a surface position of an accuracy requiring surface of a sealing member is located on a back surface side relative to a support point, the surface position is displaced toward a front surface side in advance. It is determined whether a surface displacement amount of the accuracy requiring surface relative to the support point satisfies a required reference value. When the surface displacement amount is determined to not satisfy the reference value, the sealing member is corrected by a load applied to the accuracy requiring surface until a position corresponding to a corrective deformation amount determined by adding the surface displacement amount and an elastic deformation amount allowing the sealing member to restore by its own elastic force to a normal position at which the surface displacement amount is zero, and then the load is removed.

### CROSS-REFERENCE TO RELATED APPLICATIONS

This application is based upon and claims the benefit of priority to Japanese Patent Application No. 2023-223223 filed on Dec. 28, 2023, the entire contents of which are incorporated herein by reference.

### BACKGROUND

### Technical Field

The disclosure relates to a method for manufacturing a power storage device.

### Related Art

Conventionally, in a power storage device provided with an electrode body in a case, when bonding an end part of the electrode body (a part not coated with active material) and a current collector terminal, for example, external force may be applied to the current collector terminal, causing the current collector terminal to be deformed. Due to such deformation of the current collector terminal, and so on, a sealing member of the case with positive and negative current collector terminals bonded to end parts of the electrode body at both ends in the long-side direction may be displaced in the front-back direction with surface displacement amounts asymmetric between both ends, i.e., left and right sides of the sealing member.

In this regard, for example, Japanese unexamined patent application publications No. 2009-026705 (JP 2009-026705A) and No. 2019-125486 (JP 2019-125486A) disclose the arts for reducing the deformation of current collector terminals against external force by enhancing the rigidity of the current collector terminals.

### SUMMARY

### Technical Problems

However, even if the rigidity of the current collector terminal is enhanced, the rigidity of the sealing member is generally lower than that of the current collector terminal and thus the external force acting on the current collector terminal is substantially directly transmitted to the sealing member with the current collector terminal bonded thereto. This causes a problem that the surface displacement amount of the sealing member could not be sufficiently suppressed. In addition, the surface displacement amount of the sealing member varies in magnitude for each power storage device to be manufactured. Normally, the front surface, i.e., outer surface, of the sealing member has an accuracy requiring surface that requires a better accuracy of surface positioning (surface position accuracy) than other areas, for example, like a sensor contact surface formed to be contactable with a temperature sensor for monitoring the temperature of the power storage device. The surface position accuracy of this accuracy requiring surface needs to be within a required reference value.

The present disclosure has been made to address the above problems and has a purpose to provide a method for manufacturing a power storage device with high reliability, in which even when a surface displacement amount of a sealing member varies for each power storage device to be manufactured and the surface displacement amount is asymmetric between right and left sides of each sealing member, a corrective deformation amount can be changed according to the surface displacement amount, allowing an accuracy requiring surface of the sealing member to be corrected so that the surface displacement amount is within a reference value.

### Means of Solving the Problems

(1) To solve the above-mentioned problems, one aspect of the disclosure provides a method for manufacturing a power storage device, the method including correcting a sealing member that sealingly closes an opening portion of a case containing an electrode body, prior to welding the sealing member to the opening portion of the case, wherein the sealing member has a front surface including an accuracy requiring surface that requires a required surface position accuracy, the method comprises: measuring a surface position of the accuracy requiring surface of the sealing member in a front-back direction; determining whether the surface position of the accuracy requiring surface measured in measuring the surface position is located on a front surface side or a back surface side relative to a support point of the sealing member when inserted in the opening portion; changing the surface position of the accuracy requiring surface toward the front surface side relative to the support point when the surface position of the accuracy requiring surface is determined to be located on the back surface side relative to the support point in determining the surface position; measuring a surface displacement amount of the surface position of the accuracy requiring surface in the front-back direction relative to the support point while the sealing member, for which the surface position of the accuracy requiring surface has been determined to be located on the front surface side relative to the support point in determining the surface position or the surface position of the accuracy requiring surface has been displaced toward the front surface side relative to the support point in changing the surface position, is inserted in the opening portion; and determining whether or not the surface displacement amount measured in measuring the surface displacement amount satisfies a required reference value, when it is determined, in determining the surface displacement amount, that the surface displacement amount does not satisfy the reference value, correcting the sealing member is performed by applying a load to the accuracy requiring surface toward the back surface side of the sealing member until a position corresponding to a corrective deformation amount determined by addition of the surface displacement amount and an elastic deformation amount that allows the sealing member to restore by its own elastic force to a normal position at which the surface displacement amount is zero, and then removing the load.

(2) In the method for manufacturing a power storage device, described in (1), the accuracy requiring surface may be a sensor contact surface formed to be contactable with a temperature sensor for monitoring a temperature of the power storage device.

(3) The method for manufacturing a power storage device, described in (1) or (2) may be configured such that the accuracy requiring surface in the front surface of the sealing member includes a plurality of accuracy requiring surfaces, measuring the surface position includes measuring the surface position of each of the accuracy requiring surfaces, when it is determined, in determining the surface position, that the surface position of at least one of the accuracy requiring surfaces is located on the back surface side relative to the support point, changing the surface position is performed by displacing the surface positions of all the accuracy requiring surfaces toward the front surface side relative to the support point.

(4) The method for manufacturing a power storage device, described in (1) or (2) may be configured such that the accuracy requiring surface in the front surface of the sealing member includes a plurality of accuracy requiring surfaces, measuring the surface displacement amount includes measuring the surface displacement amount of each of the accuracy requiring surfaces, when it is determined, in determining the surface displacement amount, that the surface displacement amount of at least one of the accuracy requiring surfaces does not satisfy the required reference value, correcting the sealing member is performed by applying the load to each of the accuracy requiring surfaces until a position corresponding to an average value of corrective deformation amounts each determined by addition of the surface displacement amount of each of accuracy requiring surfaces measured in measuring the surface displacement amount and the elastic deformation amount of each of the accuracy requiring surfaces, and then removing the load.

### BRIEF DESCRIPTION OF THE DRAWINGS

FIG. 1 is a schematic plan view of a power storage device manufactured by a method for manufacturing a power storage device according to one aspect of an embodiment;

FIG. 2 is a schematic cross-sectional view taken along a line A-A in FIG. 1, showing that a temperature sensor is disposed in contact with a sensor contact surface of a sealing member;

FIG. 3 is a schematic perspective view showing that an electrode body shown in FIG. 2 is partially wound back;

FIG. 4 is a cross-sectional view taken along a line B-B in FIG. 2;

FIG. 5 is a flowchart showing the method for manufacturing the power storage device shown in FIG. 1;

FIG. 6 is a schematic cross-sectional view showing a method for measuring the surface position of an accuracy requiring surface in a surface position measuring step in the flowchart shown in FIG. 5;

FIG. 7 is a schematic cross-sectional view showing a method for changing the surface position of the accuracy requiring surface by displacing the surface position toward the front surface side relative to a support point in a surface position changing step in the flowchart shown in FIG. 5;

FIG. 8 is a schematic cross-sectional view showing a method for measuring a surface displacement amount of the surface position of the accuracy requiring surface in a front-back direction relative to the support point in a surface displacement amount measuring step in the flowchart shown in FIG. 5;

FIG. 9 is a schematic cross-sectional view of a correcting device for correcting the surface displacement amount of the accuracy requiring surface to within a reference value in a correcting step in the flowchart shown in FIG. 5;

FIG. 10 is a schematic cross-sectional view of the correcting device shown in FIG. 9, in which a load is applied to a sealing member so that the accuracy requiring surface is deformed with a corrective deformation amount;

FIG. 11 is a schematic cross-sectional view of the correcting device shown in FIG. 9, in which the load applied to deform the accuracy requiring surface with the corrective deformation amount is removed; and

FIG. 12 is one example of correlation graph data indicating the correlation between the surface displacement amount of the accuracy requiring surface and the corrective deformation amount, which is used by the correcting device shown in FIG. 9.

### DETAILED DESCRIPTION OF THE EXEMPLARY EMBODIMENTS

### Description of Whole Power Storage Device

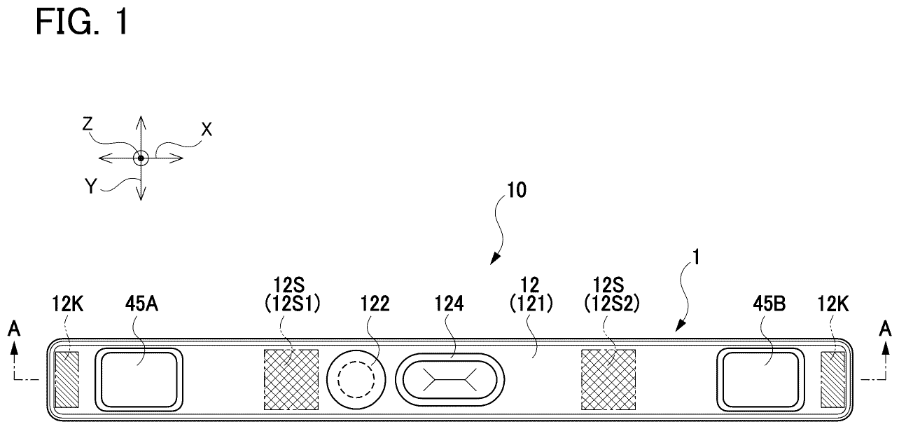

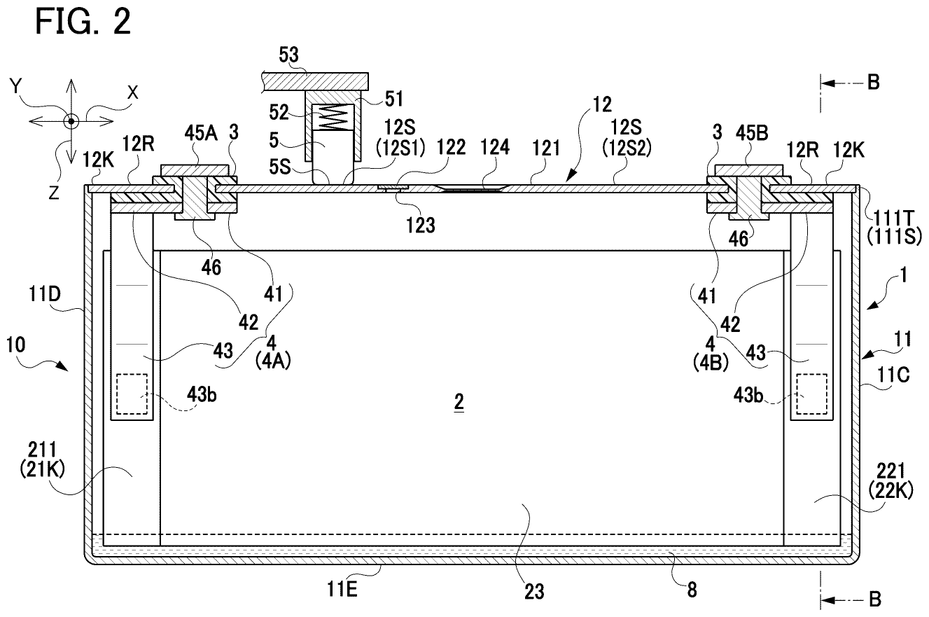

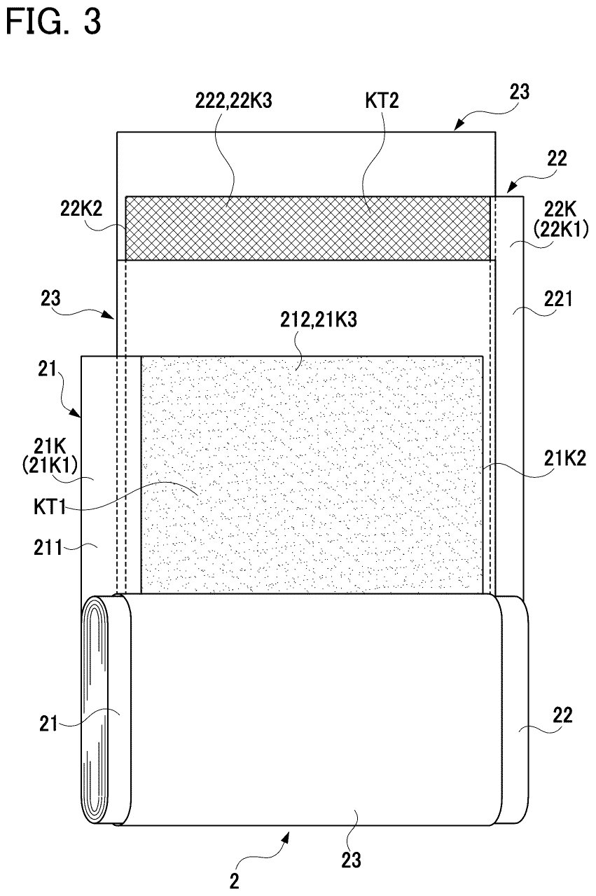

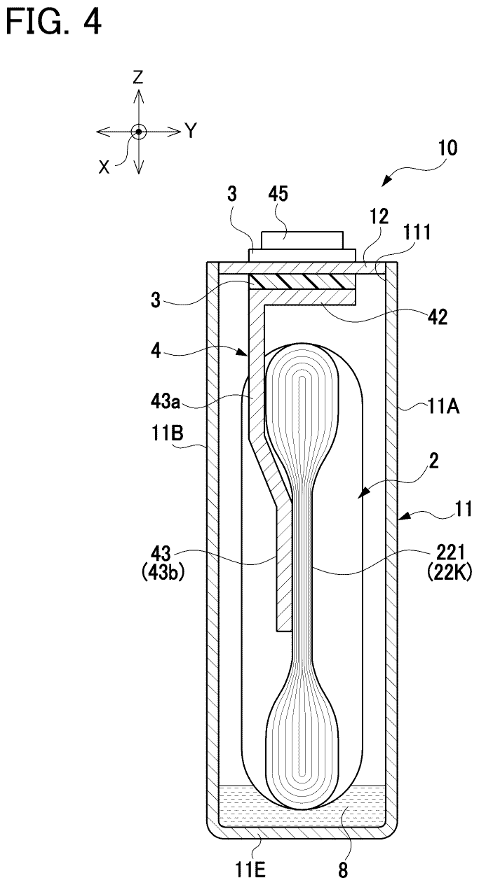

The following description will be given to the overall structure of a power storage device manufactured by a power storage device manufacturing method according to one aspect of an embodiment of the disclosure, referring to the accompanying drawings. FIG. 1 is a schematic plan view of the power storage device manufactured by the power storage device manufacturing method according to one aspect of the embodiment. FIG. 2 is a cross-sectional view taken along a line A-A in FIG. 1, showing that a temperature sensor is disposed in contact with a sensor contact surface of a sealing member. FIG. 3 is a schematic perspective view showing that an electrode body shown in FIG. 2 is partially wound back. FIG. 4 is a cross-sectional view taken along a line B-B in FIG. 2. In each figure, a direction X indicates a long-side direction of the sealing member, a direction Y indicates a short-side direction of the sealing member, and a direction Z indicates a front-back direction (i.e., a thickness direction) of the sealing member.

A power storage device 10 manufactured by the method for manufacturing the power storage device in the embodiment includes a case 1, an electrode body 2, and current collector terminals 4, as shown in FIG. 1 to FIG. 4. Herein, the case 1 has a bottomed rectangular prismatic case body 11 with a rectangular opening portion 111, and a long, flat plate-like sealing member 12 that sealingly closes the opening portion 111. The sealing member 12 is provided with a liquid inlet 123 for pouring of an electrolyte 8 into the case 1, a stopper 122 that sealingly covers the liquid inlet 123, and a safety valve 124 configured to break open when the internal pressure of the case 1 rises above a predetermined value. The case body 11 and the sealing member 12 are each made of aluminum. This sealing member 12 is specifically made of a material softer and more easily deformable than the current collector terminals 4 due to the need to improve the valve opening performance of the safety valve 124.

The opening portion 111 of the case body 11 includes a thin-walled portion 111T formed only in each inner wall of short side surfaces 11C, 11D. Therefore, each of end portions 12R on both sides in the long-side direction (the direction X) of the sealing member 12 inserted in the opening portion 111 is supported by a shoulder 111S formed at a lower end of each thin-walled portion 111T, and each end portion 12R corresponds to a support point 12K of the sealing member 12. The opening portion 111 of the case body 11 is configured such that no thin-walled portion is formed in each inner wall of long side surfaces 11A, 11B and thus is difficult to prevent the central part of the sealing member 12 from displacing (warpage deformation) in the front-back direction, i.e., the direction Z.

Further, the electrode body 2 is constituted of a positive electrode body 21 and a negative electrode body 22, stacked and wound in a flat shape with separators 23 interposed, and this electrode body 2 is housed in the case body 11 as shown in FIG. 2 to FIG. 4. The positive electrode body 21 includes an active-material uncoated part 211 where one end portion 21K1 of a metal foil 21K is not coated with an active material KT1 and an active-material coated part 212 where the metal foil 21K is coated with the active material KT1. Similarly, the negative electrode body 22 includes an active-material uncoated part 221 where one end portion 22K1 of a metal foil 22K is not coated with an active material KT2 and an active-material coated part 222 where the metal foil 22K is coated with the active material KT2. The active-material uncoated part 211 of the positive electrode body 21 and the active-material uncoated part 221 of the negative electrode body 22 are located opposite each other in the long-side direction (the direction X) of the sealing member 12. The active-material coated parts 212, 222 are respectively formed in the other end portions 21K2, 22K2 and intermediate portions 21K3, 22K3 of the metal foils 21K, 22K.

The power storage device 10 in this embodiment refers to all power storage devices that can generate electric energy to be extracted, and may include for example primary batteries, secondary batteries, electric double layer capacitors, and so on. For example, in a lithium ion secondary battery, the metal foil 21K of the positive electrode body 21 may be for example an aluminum foil, and carry thereon the active material KT1 made of e.g. lithium transition metal oxide (LiNi_{1/3}Co_{1/3}Mn_{1/3}O₂, LiNiO₂, etc.). Further, the metal foil 22K of the negative electrode body 22 may be for example a copper foil, and carry thereon the active material KT2 made of e.g. black carbon, hard carbon, soft carbon, etc. Each separator 23 may be a porous sheet, made of e.g. polypropylene, polyethylene, etc. The electrolyte 8 may be a well-known non-aqueous electrolyte.

The current collector terminals 4 include a current collector terminal 4A for positive electrode and a current collector terminal 4B for negative electrode. The positive current collector terminal 4A is made of e.g. aluminum and the negative current collector terminal 4B is made of e.g. copper. Commonly, the tension strength of the positive current collector terminal 4A made of aluminum is lower than that of the negative current collector terminal 4B made of copper, and the electric conductivity of the positive current collector terminal 4A is lower than that of the negative current collector terminal 4B. Accordingly, the thickness of the positive current collector terminal 4A is set thicker than that of the negative current collector terminal 4B to uniformize those current collector terminals 4A and 4B in strength and allowable current amount. The positive and negative current collector terminals 4 each have a base portion 41, a base adjoining portion 42, and a lead portion 43, which are formed in one piece.

The base portion 41 is connected to an external connection part 45 (45A, 45B) located on the front, i.e., outer, surface of the sealing member 12 with a swaged pin 46 or the like, for example. When the base portion 41, the external connection part 45, and the sealing member 12 are connected together with the swaged pin 46 or the like, the external force is applied to the sealing member 12, which may cause displacement of the central part of the sealing member 12 in the front-back direction (the direction Z). It is noted that an insulating member 3 also serving as a seal material is interposed between the swaged pin 46 and the sealing member 12 and between the external connection part 45 and the sealing member 12. The insulating member 3 may be made of for example polyphenylene sulfide (PPS). The external connection part 45 (45A, 45B) is connectable to a busbar (not shown) for connection of two or more power storage devices 10 of the present embodiment.

The base portion 41 is bonded to the back surface side of the end portion 12R of the sealing member 12 in the long-side direction (the direction X) via the insulating member 3. Further, the base adjoining portion 42 is adjacently continuous to the base portion 41 and in contact with the insulating member 3. A lead upper end portion 43a of the lead portion 43 is bent from the base adjoining portion 42 in a case inward direction (i.e., downward in the direction Z), and a lead lower end portion 43b is bonded by welding to the collected metal foil 21K, 22K of the active-material uncoated part 211, 221 of the electrode body 2. During welding of the electrode body 2 and the lead lower end portion 43b, the lead lower end portion 43b is apt to be subjected to an external force, and thus caused to slide on the metal foil 21K, 22K in the process of being collected together and displaced in the long-side direction of the sealing member 12, i.e., the direction X. This external force may be propagated to the sealing member 12, causing the central part of the sealing member 12 to be displaced in the front-back direction (the direction Z).

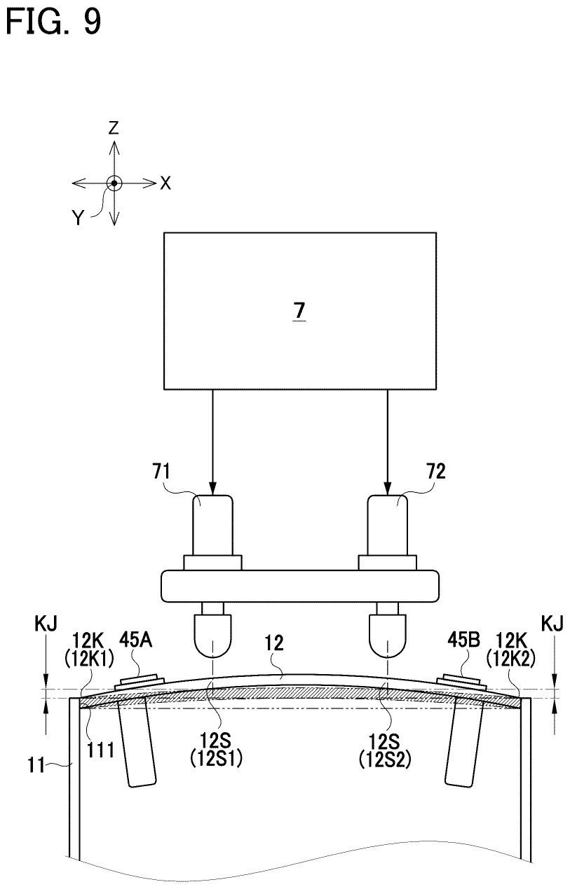

The sealing member 12 has a front surface 121 including two accuracy requiring surfaces 12S (12S1, 12S2) that require a required surface position accuracy. Herein, the accuracy requiring surfaces 12S (12S1, 12S2) are sensor contact surfaces 5S formed to be contactable with a temperature sensor 5 for monitoring the temperature of the power storage device 10, but they are not necessarily limited to the sensor contact surfaces 5S. As the temperature sensor 5, for example, a thermistor, a thermocouple, and so on, may be used. The temperature sensor 5, which is retained in a holder case 51 fixed to a mounting bracket 53, is biased into contact with the sensor contact surface 5S by a spring 52 or the like. The surface position accuracy of the accuracy requiring surface 12S (12S1, 12S2), which is the sensor contact surface 5S, is required to satisfy a required reference value KJ (see FIG. 9) in order to ensure the measurement accuracy of the temperature sensor 5 in consideration of various fabrication errors.

For constituting a battery pack by connecting two or more power storage devices 10 in series, generally, the power storage devices 10 are oriented so that the long side surfaces 11A of the case bodies 11 adjacently arranged face each other while the long side surfaces 11B of the case bodies 11 adjacently arranged face each other, so that the external connection parts 45A for positive electrode and the external connection parts 45B for negative electrode are alternately aligned in the same direction. Accordingly, the sensor contact surface 5S may be formed in the accuracy requiring surface 12S (12S1) close to the positive external connection part 45A (as seen in FIG. 2) or formed in the accuracy requiring surface 12S (12S2) close to the negative external connection part 45B. Thus, the surface position accuracy of both the accuracy requiring surfaces 12S (12S1, 12S2) is required to satisfy a required reference value KJ.

### Method for Producing the Power Storage Device

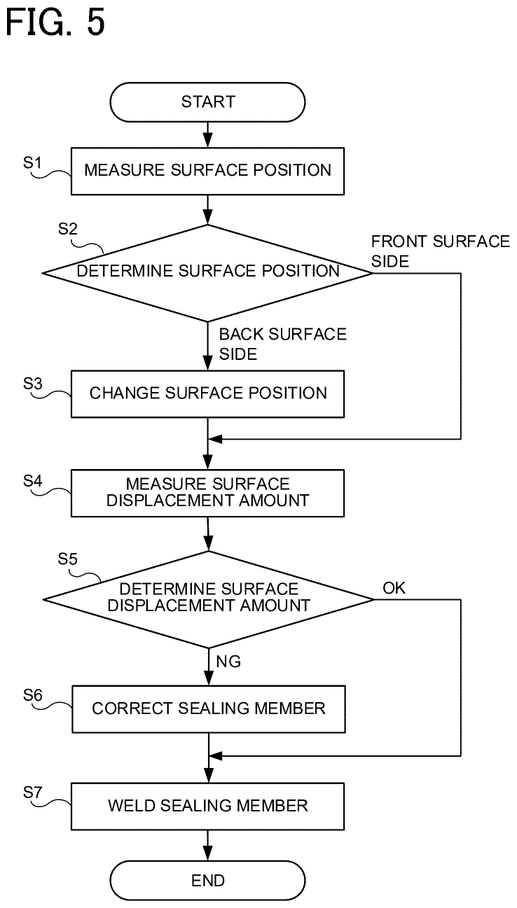

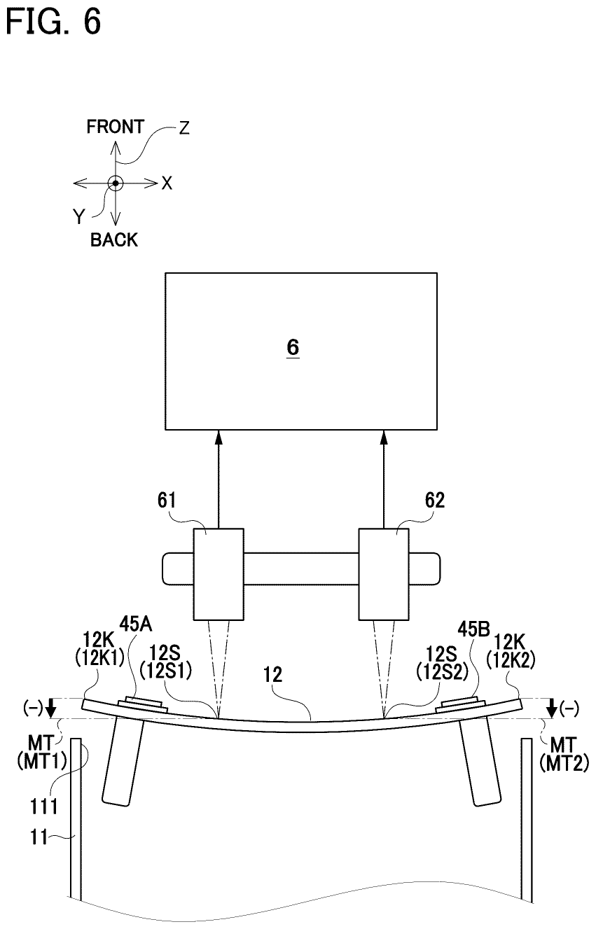

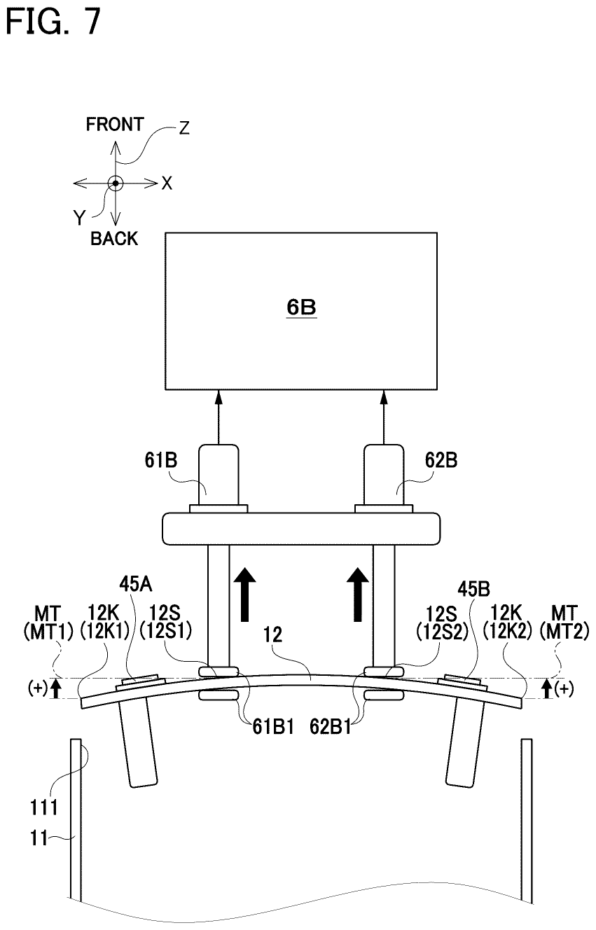

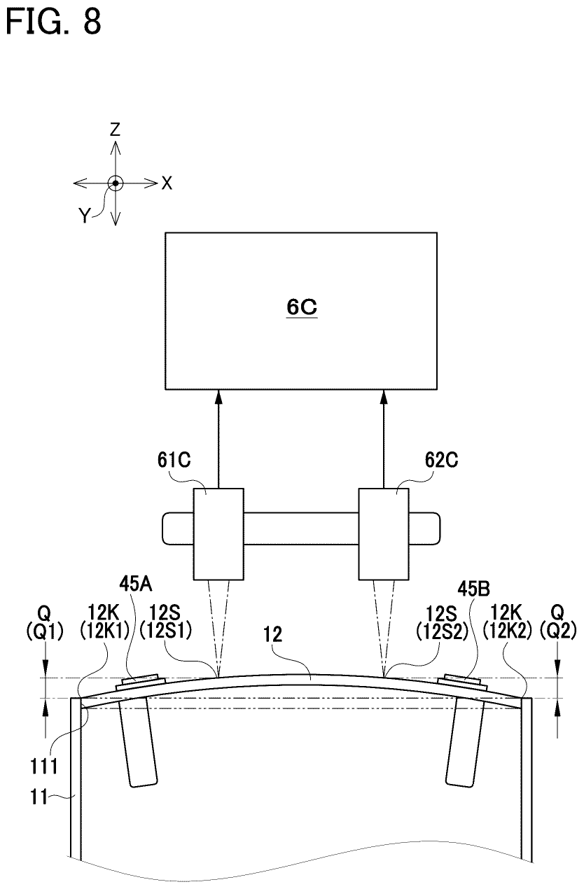

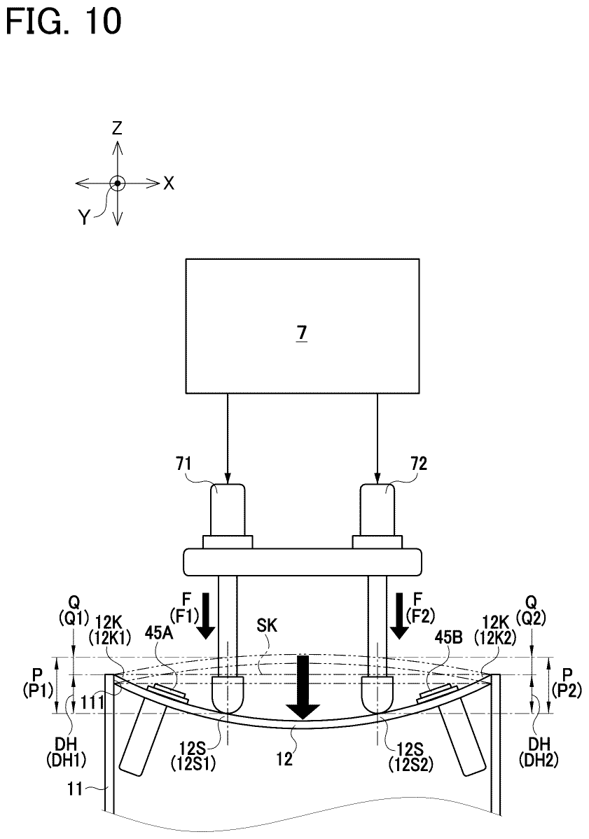

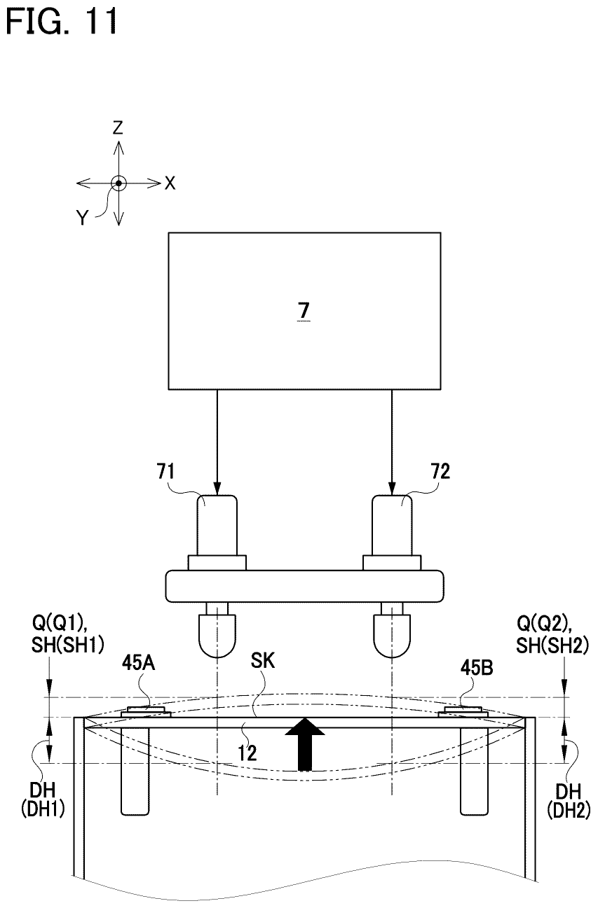

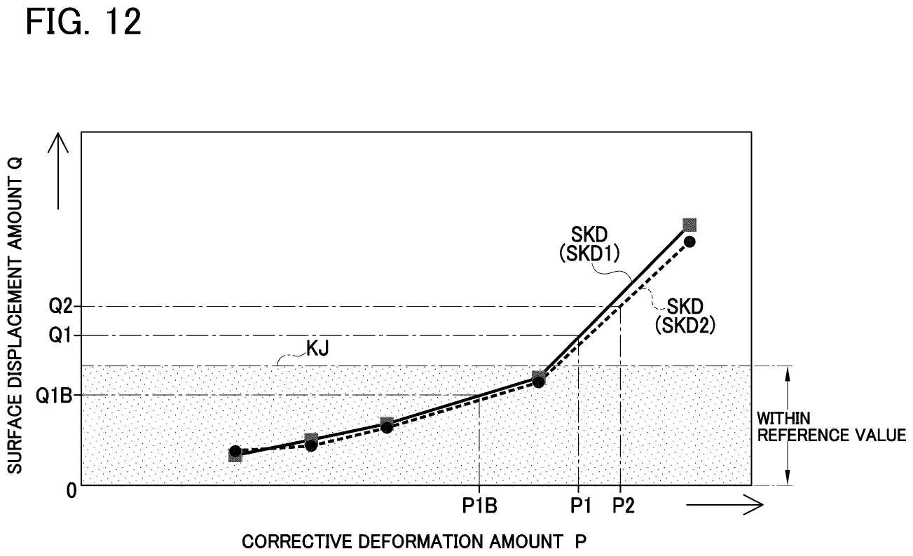

Next, the details of a method for manufacturing the power storage device in the present embodiment will be described below, referring to accompanied drawings. FIG. 5 is a flowchart showing the method for manufacturing the power storage device shown in FIG. 1. FIG. 6 is a schematic cross-sectional view showing a method for measuring the surface position of the accuracy requiring surface in a surface position measuring step in the flowchart shown in FIG. 5. FIG. 7 is a schematic cross-sectional view showing a method for changing the surface position of the accuracy requiring surface by displacing the surface position toward the front surface side relative to a support point in a surface position changing step in the flowchart shown in FIG. 5. FIG. 8 is a schematic cross-sectional view showing a method for measuring a surface displacement amount of the surface position of the accuracy requiring surface in the front-back direction relative to the support point in a surface displacement amount measuring step in the flowchart shown in FIG. 5. FIG. 9 is a schematic cross-sectional view of a correcting device for correcting the surface displacement amount of the accuracy requiring surface to within a reference value in a correcting step in the flowchart shown in FIG. 5. FIG. 10 is a schematic cross-sectional view of the correcting device shown in FIG. 9, in which a load is applied to a sealing member so that the accuracy requiring surface is deformed with a corrective deformation amount. FIG. 11 is a schematic cross-sectional view of the correcting device shown in FIG. 9, in which the load applied to deform the accuracy requiring surface with the corrective deformation amount is removed. FIG. 12 is one example of correlation graph data indicating the correlation between the surface displacement amount of the accuracy requiring surface and the corrective deformation amount, which is used by the correcting device shown in FIG. 9. In FIG. 6 to FIG. 11, the electrode body 2 is omitted, but is connected to the sealing member 12 via the current collector terminals 4 as shown in FIG. 2.

The power storage device manufacturing method in the present embodiment is a method for manufacturing the power storage device 10, including a correcting step S6 of correcting the sealing member 12 that sealingly closes the opening portion 111 of the case 1 in which the electrode body 2 is housed, prior to a sealing member welding step S7 of welding the sealing member 12 to the opening portion 111, as shown in FIG. 1 to FIG. 12. The front surface of the sealing member 12 includes the accuracy requiring surface 12S that requires a required surface position accuracy. The power storage device manufacturing method in the present embodiment includes a surface position measuring step S1, a surface position determining step S2, a surface position changing step S3, a surface displacement amount measuring step S4, a surface displacement amount determining step S5, the correcting step S6, and the sealing member welding step S7. The sealing member welding step S7 is a step of welding the outer periphery of the sealing member 12 to the opening portion 111 by laser welding or the like, in which the sealing member 12 has the accuracy requiring surface 12S whose surface displacement amount Q has been determined to satisfy the reference value KJ or the accuracy requiring surface 12S whose surface displacement amount Q has been corrected to within the reference value KJ.

Herein, the accuracy requiring surface 12S will be described using the sensor contact surface 5S as an example, which is formed to be contactable with the temperature sensor 5 for monitoring the temperature of the power storage device 10 as described above. As shown in FIG. 1, FIG. 2, and FIG. 6 to FIG. 12, the sensor contact surface 5S is a flat square or rectangle surface and formed as each of an accuracy requiring surface 12S (12S1) located close to the positive external connection part 45A and an accuracy requiring surface 12S (12S2) located close to the negative external connection part 45B. Both the accuracy requiring surfaces 12S (12S1, 12S2) are required to satisfy the required reference value KJ.

The reference value KJ indicates an allowable value or range of a surface displacement amount Q of the surface position of the accuracy requiring surface 12S (12S1, 12S2) that is displaced in the front-back direction (the direction Z) of the sealing member 12 relative to the support point 12K of the sealing member 12. This reference value KJ is about ±0.2 to 0.3 mm (i.e., within a range of about plus or minus 0.2 to 0.3 mm), for example. The displacement of the sealing member 12 toward a front surface side in the front-back direction (i.e., upward in the direction Z in FIGS. 6-11) is indicated by a plus sign (+), and the displacement of the sealing member 12 toward a back surface side in the front-back direction (i.e., downward in the direction Z in FIGS. 6-11) is indicated by a minus sign (−). The reference value KJ shown in FIGS. 9 and 12 is one example where the surface position of the accuracy requiring surface 12S (12S1, 12S2) is displaced toward the front surface side of the sealing member 12 (i.e., upward in the direction Z). Since the accuracy requiring surface 12S is the sensor contact surface 5S formed to be contactable with the temperature sensor 5 for monitoring the temperature of the power storage device 10, the measurement accuracy of the temperature sensor 5 can be enhanced with the surface displacement amount Q (Q1, Q2) of the accuracy requiring surface 12S (12S1, 12S2) falling within the reference value KJ, and the temperature of the power storage device 10 can be avoided from excessively rising. This can further enhance the safety and the reliability of the power storage device 10.

The power storage device manufacturing method in the embodiment will be described below for each of the steps in the order to be performed. In the surface position measuring step S1, firstly, the surface position MT of each of the accuracy requiring surfaces 12S of the sealing member 12 in the front-back direction (the direction Z) is measured, as shown in FIG. 6. Herein, the surface position MT (MT1, MT2) of each accuracy requiring surface 12S (12S1, 12S2) in the front-back direction of the sealing member 12 (the direction Z) is measured in a condition that both end portions of the sealing member 12 in the long-side direction (the direction X) are supported by jigs (not shown) or the like before the sealing member 12 is inserted in the opening portion 111 of the case body 11. A measuring device 6 for measuring the surface positions MT (MT1, MT2) may be for example a non-contacting measuring device including laser distance measuring devices 61, 62. Each laser distance measuring device 61, 62 measures the height of the surface position MT (MT1, MT2) by emitting a laser beam onto the center of the accuracy requiring surface 12S (12S1, 12S2). Alternatively, the surface position measuring step S1 may also be performed to measure the surface position MT of the accuracy requiring surface 12S after the sealing member 12 is inserted in the opening portion 111.

In the surface position determining step S2, subsequently, the measuring device 6 compares the surface position MT (MT1, MT2) of each of the accuracy requiring surfaces 12S (12S1, 12S2) respectively measured by the laser distance measuring devices 61, 62 and the surface position of the corresponding support point 12K used as a reference. Therefore, the measuring device 6 determines whether the surface position MT (MT1, MT2) of the accuracy requiring surface 12S (12S1, 12S2) measured in the surface position measuring step S1 is located on the front surface side or the back surface side of the sealing member 12 relative to the support point 12K (12K1, 12K2) of the sealing member 12 determined when the sealing member 12 is inserted in the opening portion 111.

When it is determined, in the surface position determining step S2, that the surface position MT (MT1, MT2) of the accuracy requiring surface 12S (12S1, 12S2) is located on the back surface side relative to the support point 12K as shown in FIG. 6, the surface position changing step S3 is performed by displacing the surface position MT (MT1, MT2) of the accuracy requiring surface 12S (12S1, 12S2) toward the front surface side relative to the support point 12K as shown in FIG. 7. A changing device 6B for changing the surface positions MT (MT1, MT2) is for example a lifting device that includes clamp parts 61B1, 61B2 for clamping the sealing member 12 from both sides in the front-back direction (i.e., from above and below in the direction Z) and is configured to lift the sealing member 12 toward the front surface side by clamping the sealing member 12 at the positions of the accuracy requiring surfaces 12S (12S1, 12S2) with the clamp parts 61B1, 61B2. In another case where the surface positions MT of the accuracy requiring surfaces 12S are measured after the sealing member 12 is inserted in the opening portion 111 in the surface position measuring step S1, the changing device 6B for changing the surface positions MT (MT1, MT2) is for example a lifting device configured to lift the sealing member 12 toward the front surface side by e.g. adsorbing the accuracy requiring surface 12S (12S1, 12S2) of the sealing member 12.

Then, the surface displacement amount measuring step S4 is performed, as shown in FIG. 8, by measuring the surface displacement amount Q (Q1, Q2) of the sealing member 12 in the front-back direction (the direction Z) relative to the support point 12K (12K1, 12K2) of the surface position MT (MT1, MT2) of each of the accuracy requiring surface 12S (12S1, 12S2), while the sealing member 12, for which the surface position MT (MT1, MT2) of each accuracy requiring surface 12S (12S1, 12S2) has been determined to be located on the front surface side relative to the support point 12K (12K1, 12K2) in the surface position determining step S2 or the surface position MT (MT1, MT2) of each accuracy requiring surface 12S (12S1, 12S2) has been displaced toward the front surface side relative to the support point 12K (12K1, 12K2) in the surface position changing step S3, is inserted in the opening portion 111. A measuring device 6C for measuring the surface displacement amounts Q (Q1, Q2) may be for example a non-contacting measuring device including laser distance measuring devices 61C, 62C. Each laser distance measuring device 61C, 62C measures the surface position MT (MT1, MT2) of the accuracy requiring surface 12S (12S1, 12S2) by emitting a laser beam onto the center of the accuracy requiring surface 12S (12S1, 12S2), and calculates a difference between the measured surface position MT and the surface position of the support point 12K (12K1,12K2) as the surface displacement amount Q (Q1, Q2) in the front-back direction (the direction Z) of the accuracy requiring surface 12S (12S1, 12S2). The measuring device 6C for measuring the surface displacement amount Q (Q1, Q2) transmits the calculated surface displacement amount Q (Q1, Q2) to the database of the correcting device 7 shown in FIG. 9. The measuring device 6C for the surface displacement amount Q (Q1, Q2) may also serve as the measuring device 6 for the surface position MT (MT1, MT2).

In the surface displacement amount determining step S5, subsequently, it is determined whether or not the surface displacement amounts Q (Q1, Q2) measured in the surface displacement amount measuring step S4 satisfy the required reference value KJ. When it is determined, in the surface displacement amount determining step S5, that either or both of the surface displacement amounts Q (Q1, Q2) do not satisfy the reference value KJ (S5: NG (no good)), the correcting step S6 is performed by activating operating part or parts 71 and 72 of the correcting device 7, as shown in FIG. 10, to apply a load F (F1, F2) to the accuracy requiring surface 12S (12S1, 12S2) toward the back surface side of the sealing member 12 until the accuracy requiring surface 12S (12S1, 12S2) reaches a position corresponding to a corrective deformation amount P (P1, P2) obtained by addition of the surface displacement amount Q (Q1, Q2) and an elastic deformation amount DH (DH1, DH2) that allows the sealing member 12 to restore by its own elastic force to a normal position SK at which the surface displacement amount Q is zero, and then the operating parts 71 and 72 of the correcting device 7 are returned to their original positions to remove the load F, as shown in FIG. 11. The operating parts 71 and 72 of the correcting device 7 may be configured to be activated by encoder-equipped servomotors to accurately control their moving amounts, or distances, of the operating parts 71, 72. Furthermore, the operating parts 71 and 72 of the correcting device 7 may also be configured to repeat, two or more times, corrective deformation of the corresponding accuracy requiring surface(s) 12S and removal of the load to gradually increase the deformation amount until reaching the predetermined corrective deformation amount P (P1, P2).

According to the power storage device manufacturing method in the present embodiment described above, the surface position measuring step S1 is performed by measuring the surface positions MT of the accuracy requiring surfaces 12S in the front-back direction (the direction Z) of the sealing member 12 and, when the surface position(s) MT is determined to be located on the back surface side relative to the support point 12K of the sealing member 12 inserted in the opening portion 111 in the surface position determining step S2, the surface position changing step S3 is performed by displacing the surface position(s) MT of the accuracy requiring surface(s) 12S toward the front surface side relative to the support point 12K. Even when the displacement direction of the sealing member 12 varies for each power storage device 10 to be manufactured, every sealing member 12 can be unified so as to displace the surface position MT of the accuracy requiring surface 12S once to the front surface side relative to the support point 12K.

When the surface displacement amount Q is determined not to satisfy the reference value KJ in the surface displacement amount determining step S5, the correcting step S6 is performed by applying the load F to the accuracy requiring surface 12S toward the back surface side of the sealing member 12 until the position corresponding to the corrective deformation amount P determined by adding the surface displacement amount Q to the elastic deformation amount DH that allows the sealing member 12 to restore by its own elastic force to the normal position SK at which the surface displacement amount Q is zero, and then removing the load F. Thus, at the stage before the sealing member 12 is welded to the opening portion 111, it is possible to correct only the sealing member 12 with the surface displacement amount Q that does not satisfy the required reference value KJ. Further, since the load F is applied to the accuracy requiring surface 12S from the front surface side to the back surface side of the sealing member 12 (i.e., from above to below in the direction Z), there is no need to apply a load F from the back surface side to the front surface side of the sealing member 12 (i.e., from below to above in the direction Z), and thus the accuracy requiring surface 12S can be corrected simply and stably to within the reference value KJ.

In the correcting step S6, the load F is applied to the accuracy requiring surface 12S toward the back surface side of the sealing member 12 until the position corresponding to the corrective deformation amount P determined by addition of the surface displacement amount Q and the elastic deformation amount DH that allows the sealing member 12 to restore by its own elastic force to the normal position SK at which the surface displacement amount Q is zero, and then the load F is removed. Accordingly, a plastic deformation amount SH for the corrected accuracy requiring surface 12S coincides with the surface displacement amount Q of the accuracy requiring surface 12S, so that the accuracy requiring surface 12S can be corrected accurately.

The elastic deformation amount DH (DH1, DH2) that allows the sealing member 12 to restore by its own elastic force to the normal position SK at which the surface displacement amount Q is zero can be mechanically calculated using CAE (Computer Aided Engineering), for example, but this calculation is complicated because it is necessary to calculate the elastic deformation amount DH (DH1, DH2) each time the surface displacement amount Q (Q1, Q2) changes. Therefore, the correlation graph data SKD may be created in advance, as shown in FIG. 12, indicating the correlation between the surface displacement amount Q of the accuracy requiring surface 12S (12S1, 12S2) in the front-back direction (the direction Z) and the corrective deformation amount P by which the accuracy requiring surface 12S (12S1, 12S2) is subjected to deformation for correction (corrective deformation) toward an opposite side in the front-back direction to the displacement direction of the accuracy requiring surface 12S (12S1, 12S2) (i.e., upward or downward in the direction Z) until the accuracy requiring surface 12S (12S1, 12S2) displaced by the surface displacement amount Q reaches the position from which it can be restored to the normal position SK by its own elastic force, and the correlation graph data SKD may be accumulated in the database of the correcting device 7. In this case, it is possible to determine the corrective deformation amount P (P1, P2) at the point in the correlation graph data SKD (SKD1, SKD2) where it corresponds to, or correlates with, the surface displacement amount Q (Q1, Q2) of the accuracy requiring surface 12S (12S1, 12S2) measured in the surface displacement amount measuring step S4, without calculating the elastic deformation amount DH (DH1, DH2) every time.

The correlation graph data SKD is created by the following steps, for example. The sealing member 12 bonded with the electrode body 2 via the current collector terminals 4 is inserted first in the opening portion 111 of the case body 11. Then, the surface position of each of the accuracy requiring surfaces 12S (12S1, 12S2) of the sealing member 12 in the front-back direction (the direction Z) is measured. A difference between the measured surface position MT of each accuracy requiring surface 12S (12S1, 12S2) and the surface position of the support point 12K serving as a reference is calculated as the surface displacement amount Q in the front-back direction (the direction Z). Further, the surface positions of the accuracy requiring surfaces 12S (12S1, 12S2) of the sealing members 12, which are different in the surface displacement amount Q, are measured and various surface displacement amounts Q are accumulated in the database of the correcting device 7.

As shown in FIG. 10, subsequently, an operating part or parts 71, 72 of the correcting device 7 are activated to perform corrective deformation of the accuracy requiring surface(s) 12S (12S1, 12S2) by applying a load F in the opposite front/back direction, which is opposite to the displacement direction of the accuracy requiring surface 12S (12S1, 12S2), until the position from which the accuracy requiring surface(s) 12S (12S1, 12S2) having been displaced by the surface displacement amount Q can be restored by its own elastic force to the normal position SK at which the surface displacement amount Q is zero. Then, as shown in FIG. 11, the operating part or parts 71, 72 are returned to their original positions to remove the load F. The correcting device 7 creates the correlation graph data SKD (SKD1, SKD2) based on the surface displacement amount Q of the accuracy requiring surface 12S (12S1, 12S2) at an initial position and the corrective deformation amount P by which the accuracy requiring surface 12S (12S1, 12S2) has been subjected to corrective deformation, as shown in FIG. 12, and stores this data in the database. Herein, the correlation graph data SKD (SKD1, SKD2) shown in FIG. 12 are plotted as line graphs, but instead may be plotted as curve graphs by increasing measurement data. The corrective deformation amount P (P1, P2) is a deformation amount that allows the accuracy requiring surface 12S (12S1, 12S2) displaced by the surface displacement amount Q (Q1, Q2) to restore by its own elastic force to the normal position SK at which the surface displacement amount Q is zero. The corrective deformation amount P (P1, P2) is therefore equal to the sum of the elastic deformation amount DH (DH1, DH2) and the plastic deformation amount SH (SH1, SH2) corresponding to the surface displacement amount Q (Q1, Q2) before correction.

Consequently, even when the surface displacement amount Q (Q1, Q2) of the accuracy requiring surface 12S (12S1, 12S2) is different for each power storage device 10 to be manufactured and the surface displacement amount Q (Q1, Q2) is asymmetric between right and left sides of the sealing member 12, an appropriate corrective deformation amount P (P1, P2) can be easily obtained according to the surface displacement amount Q (Q1, Q2) in the correlation graph data SKD (SKD1, SKD2) shown in FIG. 12. Note that the correlation graph data SKD (SKD1, SKD2) depends on the sizes, types, and other conditions of the power storage devices 10, and therefore the correlation graph data SKD (SKD1, SKD2) for each power storage device 10 may be created in advance and accumulated in the database.

The power storage device manufacturing method in the embodiment is, as described in detail above, a method for manufacturing the power storage device 10, in which the correcting step S6 of correcting the sealing member 12 sealingly closing the opening portion 111 of the case 1 containing the electrode body 2 is performed before the sealing member welding step S7 of welding the sealing member 12 to the opening portion 111. The sealing member 12 has the front surface 121 including the accuracy requiring surface 12S that requires the required surface position accuracy. This method includes the surface position measuring step S1 of measuring the surface position MT of the accuracy requiring surface 12S in the front-back direction (the direction Z) of the sealing member 12, the surface position determining step S2 of determining whether the surface position MT of the accuracy requiring surface 12S measured in the surface position measuring step S1 is located on the front surface side or the back surface side relative to the support point 12K of the sealing member 12 when inserted in the opening portion 111, the surface position changing step S3 of displacing the surface position MT of the accuracy requiring surface 12S toward the front surface side relative to the support point 12K when the surface position MT of the accuracy requiring surface 12S is determined to be located on the back surface side relative to the support point 12K in the surface position determining step S2, the surface displacement amount measuring step S4 of measuring the surface displacement amount Q of the surface position MT of the accuracy requiring surface 12S in the front-back direction (the direction Z) relative to the support point 12K while the sealing member 12, for which the surface position MT of the accuracy requiring surface 12S has been determined to be located on the front surface side relative to the support point 12K in the surface position determining step S2 or the surface position MT of the accuracy requiring surface 12S has been displaced toward the front surface side relative to the support point 12K in the surface position changing step S3, is inserted in the opening portion 111, and the surface displacement amount determining step S5 of determining whether or not the surface displacement amount Q measured in the surface displacement amount measuring step S4 satisfies the required reference value KJ. When the surface displacement amount Q does not satisfy the reference value KJ in the surface displacement amount determining step S5 (S5: NG (no good)), the correcting step S6 is performed by applying the load F to the accuracy requiring surface 12S toward the back surface side until the position corresponding to the corrective deformation amount P determined by adding the surface displacement amount Q and the elastic deformation amount DH that allows the sealing member 12 to restore by its own elastic force to the normal position SK at which the surface displacement amount Q is zero, and then removing the load F.

According to the method for manufacturing the power storage device 10 in the present embodiment, therefore, even when the surface displacement amount Q of the sealing member 12 is different for each power storage device 10 to be manufactured and this surface displacement amount Q is asymmetric between right and left sides of the sealing member 12, it is possible to manufacture a reliable power storage device by changing the corrective deformation amount P according to the surface displacement amount Q and correcting the accuracy requiring surface 12S of the sealing member 12 so that the surface displacement amount Q is within the reference value KJ.

In the power storage device manufacturing method in the present embodiment, moreover, the surface 121 of the sealing member 12 includes a plurality of accuracy requiring surfaces 12S (12S1, 12S2), the surface position measuring step S1 is performed by measuring the surface positions MT (MT1, MT2) of the accuracy requiring surfaces 12S (12S1, 12S2). When it is determined, in the surface position determining step S2, that the surface position MT of at least one of the accuracy requiring surfaces 12S (12S1, 12S2) is located on the back surface side relative relative to the support point 12K (12K1, 12K2), the surface position changing step S3 is performed by displacing the surface positions MT of all the accuracy requiring surfaces 12S toward the front surface side relative to the support point 12K (12K1, 12K2).

In this case, even though the sealing member 12 has the plurality of accuracy requiring surfaces 12S (12S1, 12S2), when the surface position MT of at least one of the accuracy requiring surfaces 12S (12S1, 12S2) is determined to be located on the back surface side relative to the support point 12K (12K1, 12K2) in the surface position determining step S2, the surface positions MT of all the accuracy requiring surfaces 12S (12S1, 12S2) are displaced toward the front surface side relative to the support point 12K (12K1, 12K2) in the surface position changing step S3. Thus, even if the accuracy requiring surfaces 12S (12S1, 12S2) has been displaced to different sides in the front-back direction (i.e., opposite each other in the direction Z), the surface positions MT of all the accuracy requiring surfaces 12S can be displaced toward the front surface side relative to the support point 12K in the surface position changing step S3.

This method can simplify the changing device 6B for displacing the accuracy requiring surface(s) 12S (12S1, 12S2) in the surface position changing step S3 and further can simplify the correcting device 7 for applying the load F (F1, F2) to the accuracy requiring surface(s) 12S (12S1, 12S2) in the correcting step S6. Consequently, the accuracy requiring surface(s) 12S of the sealing member 12 can be corrected to within the reference value KJ at a lower cost and in a shorter time.

In the power storage device manufacturing method in the present embodiment, the surface 121 of the sealing member 12 includes the plurality of accuracy requiring surfaces 12S (12S1, 12S2). In the surface displacement amount measuring step S4, the surface displacement amount Q (Q1, Q2) of each of the accuracy requiring surfaces 12S (12S1, 12S2) is measured. When the surface displacement amount Q (Q1, Q2) of at least one of the accuracy requiring surfaces 12S (12S1, 12S2) is determined to not satisfy the required reference value KJ in the surface displacement amount determining step S5, the correcting step S6 may be performed by applying the load F (F1, F2) to each of the accuracy requiring surface(s) 12S (12S1, 12S2) until each of the accuracy requiring surface(s) 12S (12S1, 12S2) reach the position corresponding to an average value ((P1B+P2)×½) of the corrective deformation amounts P (P1B, P2), which are determined by addition of the surface displacement amount Q (Q1B, Q2) of each of the accuracy requiring surfaces 12S (12S1, 12S2) measured in the surface displacement amount measuring step S4 and the elastic deformation amount DH (DH1, DH2) of each of the accuracy requiring surfaces 12S (12S1, 12S2), and then removing the load F (F1, F2).

In this case, even though the sealing member 12 has the plurality of accuracy requiring surfaces 12S (12S1, 12S2), the load F (F1, F2) is applied until the position corresponding to an average value ((P1B+P2)×½) of the corrective deformation amounts P (P1B, P2) determined by adding the surface displacement amount Q (Q1, Q2) of each accuracy requiring surface 12S (12S1, 12S2) measured in the surface displacement amount measuring step S4 to the elastic deformation amount DH (DH1, DH2) of each accuracy requiring surface 12S (12S1, 12S2), and then the load F (F1, F2) is removed. This method does not need to deform the accuracy requiring surfaces 12S (1251, 1252) separately with respective corrective deformation amounts P (P1B, P2), which can simplify the structure of the correcting device 7 to apply the load F (F1, F2) to each accuracy requiring surface 12S (1251, 1252). Consequently, the accuracy requiring surface(s) 12S of the sealing member 12 can be corrected to within the reference value KJ at a lower cost and in a shorter time.

### Modified Example

The foregoing embodiments are mere examples and give no limitation to the present disclosure. The disclosure may be embodied in other specific forms without departing from the essential characteristics thereof.

### REFERENCE SIGNS LIST

1 Case
2 Electrode body
5 Temperature sensor
5S Sensor contact surface
10 Power storage device
12 Sealing member
12K, 12K1, 12K2 Support point
12S, 12S1, 12S2 Accuracy requiring surface
111 Opening portion
121 Front surface
DH, DH1, DH2 Elastic deformation amount
F, F1, F2 Load
KJ Reference value
MT, MT1, MT2 Surface position
P, P1, P1B, P2 Corrective deformation amount
Q, Q1, Q1B, Q2 Surface displacement amount
S1 Surface position measuring step
S2 Surface position determining step
S3 Surface position changing step
S4 Surface displacement amount measuring step
S5 Surface displacement amount determining step
S6 Correcting step
S7 Sealing member welding step
SK Normal position
SKD, SKD1, SKD2 Correlation graph data

What is claimed is:

1. A method for manufacturing a power storage device, the method including correcting a sealing member that sealingly closes an opening portion of a case containing an electrode body, prior to welding the sealing member to the opening portion of the case,
wherein the sealing member has a front surface including an accuracy requiring surface that requires a required surface position accuracy,
the method comprises:
measuring a surface position of the accuracy requiring surface of the sealing member in a front-back direction;
determining whether the surface position of the accuracy requiring surface measured in measuring the surface position is located on a front surface side or a back surface side relative to a support point of the sealing member when inserted in the opening portion;
changing the surface position of the accuracy requiring surface toward the front surface side relative to the support point when the surface position of the accuracy requiring surface is determined to be located on the back surface side relative to the support point in determining the surface position;
measuring a surface displacement amount of the surface position of the accuracy requiring surface in the front-back direction relative to the support point while the sealing member, for which the surface position of the accuracy requiring surface has been determined to be located on the front surface side relative to the support point in determining the surface position or the surface position of the accuracy requiring surface has been displaced toward the front surface side relative to the support point in changing the surface position, is inserted in the opening portion; and
determining whether or not the surface displacement amount measured in measuring the surface displacement amount satisfies a required reference value,
when it is determined, in determining the surface displacement amount, that the surface displacement amount does not satisfy the reference value, correcting the sealing member is performed by applying a load to the accuracy requiring surface toward the back surface side of the sealing member until a position corresponding to a corrective deformation amount determined by addition of the surface displacement amount and an elastic deformation amount that allows the sealing member to restore by its own elastic force to a normal position at which the surface displacement amount is zero, and then removing the load.

2. The method for manufacturing a power storage device, according to claim 1, wherein the accuracy requiring surface is a sensor contact surface formed to be contactable with a temperature sensor for monitoring a temperature of the power storage device.

3. The method for manufacturing a power storage device, according to claim 1, wherein the accuracy requiring surface in the front surface of the sealing member includes a plurality of accuracy requiring surfaces,
measuring the surface position includes measuring the surface position of each of the accuracy requiring surfaces,
when it is determined, in determining the surface position, that the surface position of at least one of the accuracy requiring surfaces is located on the back surface side relative to the support point, changing the surface position is performed by displacing the surface positions of all the accuracy requiring surfaces toward the front surface side relative to the support point.

4. The method for manufacturing a power storage device, according to claim 2, wherein the accuracy requiring surface in the front surface of the sealing member includes a plurality of accuracy requiring surfaces,
measuring the surface position includes measuring the surface position of each of the accuracy requiring surfaces,
when it is determined, in determining the surface position, that the surface position of at least one of the accuracy requiring surfaces is located on the back surface side relative to the support point, changing the surface position is performed by displacing the surface positions of all the accuracy requiring surfaces toward the front surface side relative to the support point.

5. The method for manufacturing a power storage device, according to claim 1, wherein the accuracy requiring surface in the front surface of the sealing member includes a plurality of accuracy requiring surfaces,
measuring the surface displacement amount includes measuring the surface displacement amount of each of the accuracy requiring surfaces,
when it is determined, in determining the surface displacement amount, that the surface displacement amount of at least one of the accuracy requiring surfaces does not satisfy the required reference value, correcting the sealing member is performed by applying the load to each of the accuracy requiring surfaces until a position corresponding to an average value of corrective deformation amounts each determined by addition of the surface displacement amount of each of accuracy requiring surfaces measured in measuring the surface displacement amount and the elastic deformation amount of each of the accuracy requiring surfaces, and then removing the load.

6. The method for manufacturing a power storage device, according to claim 2, wherein the accuracy requiring surface in the front surface of the sealing member includes a plurality of accuracy requiring surfaces,
measuring the surface displacement amount includes measuring the surface displacement amount of each of the accuracy requiring surfaces,
when it is determined, in determining the surface displacement amount, that the surface displacement amount of at least one of the accuracy requiring surfaces does not satisfy the required reference value, correcting the sealing member is performed by applying the load to each of the accuracy requiring surfaces until a position corresponding to an average value of corrective deformation amounts each determined by addition of the surface displacement amount of each of accuracy requiring surfaces measured in measuring the surface displacement amount and the elastic deformation amount of each of the accuracy requiring surfaces, and then removing the load.
